(19) United States
(12) Patent Application Publication
(10) Pub. No.: US 2016/0016846 A1
(43) Pub. Date: Jan. 21, 2016

(54) METHOD FOR HEAT-TREATING A COATING

(71) Applicant: SAINT-GOBAIN GLASS FRANCE, Courbevoie (FR)

(72) Inventors: Lorenzo CANOVA, Paris (FR); Jean Philippe SCHWEITZER, Chamant (FR); Xavier BRAJER, Cormeilles En Parisis (FR)

(21) Appl. No.: 14/771,630

(22) PCT Filed: Feb. 27, 2014
(86) PCT No.: PCT/FR2014/050431

§ 371 Date: Aug. 31, 2015

(30) Foreign Application Priority Data
Mar. 1, 2013 (FR) 1351840

(51) Int. Cl. C03C 17/00; C03C 17/36

(52) U.S. Cl. CPC C03C 17/001; C03C 17/3618; C03C 17/3644; C03C 2218/32

(57) ABSTRACT

A process for the heat treatment of a coating deposited on at least one portion of a first face of a substrate including a first face and a second face opposite the first face, wherein the coating is treated by a laser radiation focused on the coating in the form of a laser line extending along a first direction, the heat treatment being such that, in a second direction transverse to the first direction, a relative displacement movement is created between the substrate and the laser line, wherein the second face is heated locally at a temperature of at least 30° C. in an additional heating zone extending facing the laser line over a length of at least 10 cm along the second direction, with the aid of at least one additional heater positioned on the side opposite the laser line with respect to the substrate.

The invention relates to the heat treatment of substrates provided with coatings using a laser radiation.

It is known in the microelectronics field to heat treat coatings (for example made of silicon) deposited on substrates using focused laser lines, typically excimer lasers that emit in the ultraviolet. These processes are commonly used for obtaining polycrystalline silicon from amorphous silicon, by local melting of the silicon and recrystallization on cooling. Conventionally, the excellent flatness of the substrates used in microelectronics, their small size, and the industrial environment typical in this type of industry make it possible to position the substrate very accurately in the laser focal spot in order to treat the whole of the substrate homogeneously and optimally. The slow treatment speeds allow the use, for the displacement of the substrates, of air-cushion table systems. If necessary, systems that make it possible to control the position of the substrate with respect to the laser focal spot may correct possible flatness defects or the presence of low-frequency vibrations. The control systems are compatible with the slow treatment speeds used.

Laser line treatments are also envisaged in order to heat treat layers on glass or a polymeric organic substrate for various industrial applications: mention may be made, by way of example, of the production of self-cleaning glazing comprising TiO₂-based coatings, the production of low-emissivity glazing containing a glass substrate coated with a multilayer stack comprising at least one silver layer, described in application WO 2010/142926, or the production of large-sized substrates for photovoltaic cells comprising transparent and conductive (TCO) thin films, described in application WO 2010/139908.

The industrial and economic context here is totally different. Typically, the substrates to be treated may be very large sheets of glass, the surface area of which is of the order of 6*3 m², therefore the flatness of which cannot be controlled accurately (for example to within ±1 mm), moved at high speed (sometimes of the order of 10 m/minute or more) on industrial conveyors on exiting deposition machines (for example sputtering deposition machines), therefore in an industrial environment that generates vibrations which may be large. Therefore, the position of each point of the coating to be treated with respect to the focal plane of the laser may vary significantly, resulting in large treatment heterogeneities. The high speeds of travel of the substrates make it extremely difficult or even impossible to put in place systems for mechanically controlling the position of the substrate.

The inventors have been able to demonstrate that during passage under the laser line, the substrate was deformed slightly in a limited area, typically of the order of around ten centimeters in the run direction. This deformation, even very slight, for example of the order of a few hundreds of micrometers in the direction of the laser line, shifts the coating with respect to the laser focal spot, and adds to the flatness defects and to the vibrations due to the conveying. Without wishing to be tied to any one scientific theory, it would appear that the heat generated by the laser line diffuses into the substrate over a depth of a few tens of micrometers, the generated temperature gradient inducing a bending moment that is even higher when the thickness of the substrate is low.

The objective of the invention is to overcome this problem.

For this purpose, one subject of the invention is a process for the heat treatment of a coating deposited on at least one portion of a first face of a substrate comprising a first face and a second face opposite said first face, wherein said coating is treated by means of a laser radiation focused on said coating in the form of a laser line extending along a first direction, said heat treatment being such that, in a second direction transverse to said first direction, a relative displacement movement is created between said substrate and said laser line, said process being characterized in that said second face is heated locally at a temperature of at least 30° C. in an additional heating zone extending facing said laser line over a length of at least 10 cm along said second direction, with the aid of at least one additional heating means positioned on the side opposite said laser line with respect to said substrate.

Another subject of the invention is a process for obtaining a substrate provided with a coating on at least one portion of a first face comprising a step of depositing said coating on said first face then a step of heat treatment of said coating according to the process described above.

Another subject of the invention is a device for implementing the process according to the invention, comprising at least one laser source, forming and redirecting means capable of generating a laser radiation focused on a coating, deposited on a first face of a substrate, in the form of a laser line extending along a first direction, displacement means suitable for creating, during operation, a relative displacement movement between said substrate and said laser line, and additional heating means positioned on the side opposite said laser line with respect to said substrate suitable for locally heating the second face of said substrate at a temperature of at least 30° C. over an additional heating zone extending facing said laser line over a length of at least 10 cm, along said second direction.

The inventors have been able to demonstrate that at the same time as the laser treatment, the application of moderate additional heating to a very precise zone of the face opposite the treated face (referred to as “additional heating zone”) facing the laser line, but having a dimension much larger than that of the laser line, made it possible to reduce or even eliminate the aforementioned thermomechanical deformation. The expression “facing” is preferably understood to mean that the additional heating zone is passed through by the normal to the substrate passing through the laser line or at the very least is close thereto (the furthest upstream part of the additional heating zone being at most a few centimeters, typically 5 cm, or 1 cm away from this normal). The expression “additional heating means” is understood to mean that a heating means other than the laser is used. In particular, the heating means may not be formed by the reflection of the portion of the laser radiation transmitted through the substrate, as described in application WO 2012/120238.

Preferably, the process according to the invention has at least one of the following preferred features, in all possible combinations:
the first direction (direction of the laser line) is preferably perpendicular to the second direction (which will also be referred to as the displacement direction).
the speed of the relative displacement movement between the substrate and the laser line is at least 4 m/min, in particular 5 m/min and even 6 m/min or 7 m/min, or else 8 m/min and even 9 m/min or 10 m/min.
the second face is heated locally over an additional heating zone extending facing the laser line over a length of at least 20 cm, in particular 30 cm and even 35 cm along the second direction (displacement direction). This length is advantageously at most 80 cm, in particular 60 cm and even 50 cm. This is because it has proved pointless to heat too large a zone.
the second face is heated locally over a zone extending facing the laser line over a width equal to the length of the laser line along the first direction.
the additional heating zone has, in the first direction, a width equal to the length of the laser line, and, in the second direction, a length of at least 20 cm, in particular 30 cm and even 35 cm, and at most 80 cm, in particular 60 cm and even 50 cm.
the additional heating zone is such that the ratio between its surface area extending downstream of the laser line and its surface area extending upstream of the laser line is within a range extending from 40:60, in particular 50:50, to 80:20, or 90:10. The term “downstream” is understood to mean the zone of the substrate that has just been treated by the laser line, in other words the zone located after the laser line in the process direction. Specifically, it is in this zone that the deformation is largest and that it is advisable to compensate it as much as possible.
the length of the laser line is at least 0.8 m or 1 m, in particular 2 m and even 3 m.
the mean width of the laser line is at least 35 micrometers, in particular within a range extending from 40 to 100 micrometers or from 40 to 70 micrometers.
the second face is heated locally at a temperature of at least 40° C., or 50° C. in the additional heating zone.
the maximum temperature to which each point of the coating is subjected during the heat treatment is at least 300° C., in particular 350° C., or 400° C., and even 500° C. or 600° C. The maximum temperature is normally experienced when the point of the coating in question passes under the laser line. At a given instant, only the points of the surface of the coating located under the laser line and in the immediate vicinity thereof (for example less than one millimeter away) are normally at a temperature of at least 300° C. For distances to the laser line (measured along the second direction) of greater than 2 mm, in particular 5 mm, including downstream of the laser line, the temperature of the coating is normally at most 50° C., and even 40° C. or 30° C.
each point of the coating is subjected to the heat treatment (or is brought to the maximum temperature) over a time within a range extending from 0.05 to 10 ms, in particular from 0.1 to 5 ms, or from 0.1 to 2 ms. This time is set both by the width of the laser line and by the speed of relative displacement between the substrate and the laser line.
the relative difference ΔT (T₂−T₁) between the mean temperature T₂ of the second face of the substrate in the additional heating zone and the mean temperature T₁ of the coating in the zone having the same surface area as said additional heating zone and exactly opposite said additional heating zone is at least 0° C., in particular +5° C., or +10° C. or +15° C., particularly for substrate thicknesses of 3 to 5 mm. The relative difference ΔT is advantageously at least +15° C., in particular +20° C. or even +30° C. in particular for substrate thicknesses of 1 to 3 mm. The relative difference ΔT is advantageously at most +100° C., in particular +50° C. The temperatures are typically measured using an infrared camera at various points of the coating or of the second face, for example 5 or 10 points, so as to establish an arithmetic mean. Typically, for mean temperatures T₁ of 30° C., the temperature T₂ of the second face will be at least 38° C. or 40° C.

The or each additional heating means is preferably selected from radiant heating means, convective heating means, conductive heating means or any combination thereof.

Among the radiant heating means, mention may especially be made of infrared radiant heating means, for example infrared lamps.

Among the convective heating means, mention may especially be made of nozzles blowing a hot gas, typically hot air.

Among the conductive heating means, mention may especially be made of a hot surface, for example a heated roller, in contact with which the second face of the substrate will come. The roller may be heated by various techniques, for example by the Joule effect, or may be heated by the laser radiation transmitted through the substrate, therefore without supplementary energy input. The hot surface may also be a coating, typically an absorbent coating, for example made of graphite, deposited on the second face of the substrate and heated indirectly by the laser radiation. In order to do this, it is possible to diffusely reflect the portion of the laser radiation transmitted through the substrate.

Preferably, the substrate, which is generally substantially horizontal, moves on a conveyor facing the or each laser line, the or each laser line being fixed and positioned along a first direction substantially perpendicular to the displacement direction (second direction). The or each laser line may be positioned above and/or below the substrate. The additional heating means are themselves positioned on the side opposite the laser line with respect to the substrate. Typically, the laser line is positioned above the substrate and the additional heating means below the substrate.

Other embodiments are of course possible. For example, the substrate may be fixed, the or each laser line and the additional heating means being moved facing the substrate, in particular with the aid of at least one mobile gantry. The or each laser line may also not be positioned perpendicular to the displacement direction, but diagonally, along any possible angle. The substrate may also be displaced over a plane which is not horizontal, but vertical, or along any possible orientation.

The laser radiation is preferably generated by modules comprising one or more laser sources and also forming and redirecting optics.

The laser sources are typically laser diodes or fiber or disk lasers. Laser diodes make it possible to economically achieve high power densities with respect to the electrical supply power for a small space requirement. The space requirement of fiber lasers is even smaller, and the linear power density obtained may be even higher, for a cost that is however greater.

The radiation resulting from the laser sources is preferably continuous.

The wavelength of the radiation of the or each laser line is preferably within a range extending from 800 to 1100 nm, in particular from 800 to 1000 nm. High-power laser diodes that emit at a wavelength selected from 808 nm, 880 nm, 915 nm, 940 nm or 980 nm have proved particularly suitable.

The forming and redirecting optics preferably comprise lenses and mirrors, and are used as means for positioning, homogenizing and focusing the radiation.

The purpose of the positioning means is, where appropriate, to arrange the radiation emitted by the laser sources along a line. They preferably comprise mirrors. The purpose of the homogenization means is to superpose the spatial profiles of the laser sources in order to obtain a homogeneous linear power density along the whole of the line. The homogenization means preferably comprise lenses that enable the separation of the incident beams into secondary beams and the recombination of said secondary beams into a homogeneous line. The radiation-focusing means make it possible to focus the radiation on the coating to be treated, in the form of a line of desired length and width. The focusing means preferably comprise a convergent lens.

When a single laser line is used, the length of the line is advantageously equal to the width of the substrate. This length is typically at least 1 m, in particular 2 m and even 3 m. It is also possible to use several lines, separated or not separated, but positioned so as to treat the entire width of the substrate. In this case, the length of each laser line is preferably at least 10 cm or 20 cm, in particular within a range extending from 30 to 100 cm, in particular from 30 to 75 cm, or even from 30 to 60 cm.

The term “length” of the line is understood to mean the largest dimension of the line, measured on the surface of the coating in the first direction, and the term “width” is understood to mean the dimension in the second direction. As is customary in the field of lasers, the width w of the line corresponds to the distance (along this second direction) between the axis of the beam (where the intensity of the radiation is at a maximum) and the point where the intensity of the radiation is equal to 1/e² times the maximum intensity. If the longitudinal axis of the laser line is referred to as x, it is possible to define a width distribution along this axis, referred to as w(x).

The mean width of the or each laser line is preferably at least 35 micrometers, in particular within a range extending from 40 to 100 micrometers or from 40 to 70 micrometers. Throughout the present text the term “mean” is understood to mean the arithmetic mean. Over the entire length of the line, the width distribution is narrow in order to avoid any treatment heterogeneity. Thus, the difference between the largest width and the smallest width is preferably at most 10% of the value of the mean width. This number is preferably at most 5% and even 3%.

The forming and redirecting optics, in particular the positioning means, may be adjusted manually or with the aid of actuators that make it possible to adjust their positioning remotely. These actuators (typically piezoelectric motors or blocks) may be controlled manually and/or be adjusted automatically. In the latter case, the actuators will preferably be connected to detectors and also to a feedback loop.

At least part of the laser modules, or even all of them, is preferably arranged in a leaktight box, which is advantageously cooled, and especially ventilated, so as to ensure their heat stability.

The laser modules are preferably mounted on a rigid structure referred to as a “bridge”, based on metallic elements, typically made of aluminum. The structure preferably does not comprise a marble slab. The bridge is preferably positioned parallel to the conveying means so that the focal plane of the or each laser line remains parallel to the surface of the substrate to be treated. Preferably, the bridge comprises at least four feet, the height of which can be individually adjusted in order to ensure a parallel positioning in all circumstances. The adjustment may be provided by motors located at each foot, either manually or automatically, in connection with a distance sensor. The height of the bridge may be adapted (manually or automatically), in order to take into account the thickness of the substrate to be treated, and to thus ensure that the plane of the substrate coincides with the focal plane of the or each laser line.

The linear power density of the laser line is preferably at least 300 W/cm, advantageously 350 or 400 W/cm, in particular 450 W/cm, or 500 W/cm and even 550 W/cm. It is even advantageously at least 600 W/cm, in particular 800 W/cm, or 1000 W/cm. The linear power density is measured at the place where the or each laser line is focused on the coating. It may be measured by placing a power detector along the line, for example a calorimetric power meter, such as in particular the Beam Finder S/N 2000716 power meter from the company Coherent Inc. The power is advantageously distributed homogeneously over the entire length of the or each line. Preferably, the difference between the highest power and the lowest power is equal to less than 10% of the mean power.

The energy density provided to the coating is preferably at least 20 J/cm², or even 30 J/cm².

The laser radiation is partly reflected by the coating to be treated and partly transmitted through the substrate. For safety reasons, it is preferable to place radiation-stopping means in the path of these reflected and/or transmitted radiations. These radiation-stopping means will typically be metal boxes cooled by circulation of fluid, in particular water. To prevent the reflected radiation from damaging the laser modules, the axis of propagation of the or each laser line forms a preferably non-zero angle with the normal to the substrate, typically an angle between 5° and 20°.

In order to improve the effectiveness of the treatment, it is preferable for at least one portion of the (main) laser radiation transmitted through the substrate and/or reflected by the coating to be redirected in the direction of said substrate in order to form at least one secondary laser radiation, which preferably impacts the substrate at the same location as the main laser radiation, advantageously with the same focus depth and the same profile. The formation of the or each secondary laser radiation advantageously uses an optical assembly comprising only optical elements selected from mirrors, prisms and lenses, in particular an optical assembly consisting of two mirrors and a lens, or of a prism and a lens. By recovering at least one portion of the main radiation lost and by redirecting it toward the substrate, the heat treatment is considerably improved thereby. The choice of using the portion of the main radiation transmitted through the substrate (“transmission” mode) or the portion of the main radiation reflected by the coating (“reflection” mode), or optionally of using both, depends on the nature of the layer and on the wavelength of the laser radiation.

When the substrate is moving, in particular translationally, it may be moved using any mechanical conveying means, for example using belts, rollers or trays running translationally. The conveying system makes it possible to control and regulate the run speed. The conveying means preferably comprises a rigid chassis and a plurality of rollers. The pitch of the rollers is advantageously within a range extending from 50 to 300 mm. The rollers probably comprise metal rings, typically made of steel, covered with plastic wrappings. The rollers are preferably mounted on bearings with reduced clearance, typically in a proportion of three rollers per bearing. In order to ensure perfect flatness of the conveying plane, the positioning of each of the rollers is advantageously adjustable. The rollers are preferably moved using pinions or chains, preferably tangential chains, driven by at least one motor.

The speed of the relative displacement movement between the substrate and the or each laser line is advantageously at least 4 m/min, in particular 5 m/min and even 6 m/min or 7 m/min, or else 8 m/min and even 9 m/min or 10 m/min. According to certain embodiments, in particular when the absorption of the coating at the length of the laser is high or when the coating may be deposited with high deposition rates, the speed of the relative displacement movement between the substrate and the or each laser line is at least 12 m/min or 15 m/min, in particular 20 m/min and even 25 or 30 m/min. In order to ensure a treatment that is as homogeneous as possible, the speed of the relative displacement movement between the substrate and the or each laser line varies during the treatment by at most 10% in relative terms, in particular 2% and even 1% with respect to its nominal value.

The heat treatment device according to the invention may be integrated into a layer deposition line, for example a magnetron sputtering deposition line (magnetron process) or a chemical vapor deposition (CVD) line, especially a plasma-enhanced (PECVD) line, under vacuum or at atmospheric pressure (AP-PECVD). In general, the line includes substrate handling devices, a deposition unit, optical control devices and stacking devices. For example, the substrates run on conveyor rollers, in succession past each device or each unit.

The heat treatment device according to the invention is preferably located just after the coating deposition unit, for example at the exit of the deposition unit. The coated substrate may thus be treated in line after the coating has been deposited, at the exit of the deposition unit and before the optical control devices, or after the optical control, devices and before the substrate stacking devices.

The heat treatment device may also be integrated into the deposition unit. For example, the laser may be introduced into one of the chambers of a sputtering deposition unit, especially into a chamber in which the atmosphere is rarefied, especially at a pressure between 10⁻⁶ mbar and 10⁻² mbar. The heat treatment device may also be placed outside the deposition unit, but so as to treat a substrate located inside said unit. It is sufficient to provide, for this purpose, a window transparent to the wavelength of the radiation used, through which the laser radiation passes to treat the layer. It is thus possible to treat a layer (for example a silver layer) before the subsequent deposition of another layer in the same unit.

Whether the heat treatment device is outside the deposition unit or integrated thereinto, these “in-line” processes are preferable to a process involving off-line operations, in which it would be necessary to stack the glass substrates between the deposition step and the heat treatment.

However, processes involving off-line operations may have an advantage in cases in which the heat treatment according to the invention is carried out in a place different from that where the deposition is carried out, for example in a place where conversion of the glass takes place. The heat treatment device may therefore be integrated into lines other than the layer deposition line. For example, it may be integrated into a multiple glazing (especially double or triple glazing) manufacturing line or into a laminated glazing manufacturing line, or else into a bent and/or tempered glazing manufacturing line. Laminated or bent or tempered glazing may be used both as building glazing or motor vehicle glazing. In these various cases, the heat treatment according to the invention is preferably carried out before the multiple glazing or laminated glazing is produced. The heat treatment may however be carried out after the double glazing or laminated glazing is produced.

The heat treatment device is preferably positioned in a closed chamber that makes it possible to protect people by preventing any contact with the laser radiation and to prevent any pollution, in particular of the substrate, optics, or treatment zone.

The multilayer stack may be deposited on the substrate by any type of process, in particular processes generating predominantly amorphous or nanocrystalline layers, such as the sputtering, especially magnetron sputtering, process, the plasma-enhanced chemical vapor deposition (PECVD) process, the vacuum evaporation process or the sol-gel process.

Preferably, the multilayer stack is deposited by sputtering, especially magnetron sputtering.

For greater simplicity, the heat treatment of the multilayer stack preferably takes place in air and/or at atmospheric pressure. However, it is possible for the heat treatment of the multilayer stack to be carried out within the actual vacuum deposition chamber, for example before a subsequent deposition.

The substrate is preferably made of glass or of glass-ceramic. It is preferably transparent, colorless (it is then a clear or extra-clear glass) or colored, for example blue, gray, green or bronze. The glass is preferably of soda-lime-silica type, but it may also be glass of borosilicate or alumino-borosilicate type. The substrate advantageously has at least one dimension greater than or equal to 1 m, or 2 m and even 3 m. The thickness of the substrate generally varies between 0.1 mm and 19 mm, preferably between 0.7 and 9 mm, in particular between 1 and 6 mm, or even between 2 and 4 mm. Since the deformation of the substrate is even greater when its thickness is small, the process according to the invention is particularly well suited to glass substrates, the thickness of which is within a range extending from 0.1 to 4 mm, in particular from 0.5 to 3 mm.

The glass substrate is preferably of float glass type, that is to say capable of having been obtained by a process that consists in pouring the molten glass onto a bath of molten tin (“float” bath). In this case, the coating to be treated may equally be deposited on the “tin” side as on the “atmosphere” side of the substrate. The terms “atmosphere” and “tin” sides are understood to mean the sides of the substrate that have respectively been in contact with the atmosphere prevailing in the float bath and in contact with the molten tin. The tin side contains a small superficial amount of tin that has diffused into the structure of the glass. The glass substrate may also be obtained by rolling between two rolls, a technique that makes it possible in particular to imprint patterns onto the surface of the glass.

Preferably, the substrate does not bear a coating on the second face.

The heat treatment is preferably intended to improve the crystallization of the coating, in particular by an increase in the size of the crystals and/or in the amount of crystalline phase. The heat treatment may also be intended to oxidize a layer of a metal or of a metal oxide that is sub-stoichiometric in oxygen, optionally by promoting the growth of a particular crystalline phase.

Preferably, the heat treatment step does not perform melting, even partial melting, of the coating. In the cases where the treatment is intended to improve the crystallization of the coating, the heat treatment makes it possible to provide sufficient energy to promote the crystallization of the coating by a physicochemical mechanism of crystalline growth around nuclei already present in the coating, while remaining in the solid phase. This treatment does not use a mechanism of crystallization by cooling starting from a molten material, on the one hand because that would require extremely high temperatures and, on the other hand, because that would be capable of modifying the thicknesses or the refractive indices of the coating, and therefore its properties, by modifying, for example, its optical appearance.

The heat treatment according to the invention is particularly well suited to the treatment of coatings that are weakly absorbent at the wavelength of the laser. The absorption of the coating at the wavelength of the laser is preferably at least 5%, in particular 10%. It is advantageously at most 90%, in particular 80% or 70%, or 60% or 50%, and even 40% or else 30%.

The coating treated preferably comprises a thin layer selected from metal layers (in particular based on or consisting of silver or molybdenum), titanium oxide layers and transparent electrically conductive layers.

The transparent electrically conductive layers are typically based on mixed indium tin oxides (referred to as “ITOs”), based on mixed indium zinc oxides (referred to as “IZOs”), based on gallium-doped or aluminum-doped zinc oxide, based on niobium-doped titanium oxide, based on cadmium or zinc stannate, or based on tin oxide doped with fluorine and/or with antimony. These various layers have the distinctive feature of being layers that are transparent and nevertheless conductive or semiconductive, and are used in many systems where these two properties are necessary: liquid crystal displays (LCDs), solar or photovoltaic collectors, electrochromic or electroluminescent devices (in particular LEDs, OLEDs), etc. Their thickness, generally driven by the desired sheet resistance, is typically between 50 and 1000 nm, limits included.

The thin metallic layers, for example based on metallic silver, but also based on metallic molybdenum or metallic niobium, have electrical conduction and infrared radiation reflection properties, hence their use in solar-control glazing, in particular solar-protection glazing (with the aim of reducing the amount of incoming solar energy) or low-emissivity glazing (with the aim of reducing the amount of energy dissipated to the outside of a building or a vehicle). Their physical thickness is typically between 4 and 20 nm (limits included). The low-emissivity multilayer stacks may frequently comprise several silver layers, typically two or three. The or each silver layer is generally surrounded by dielectric layers that protect it from corrosion and make it possible to adjust the appearance of the coating in reflection. Molybdenum is frequently used as an electrode material for photovoltaic cells based on CuInₓGa₁₋ₓSe₂, where x varies from 0 to 1. The treatment according to the invention makes it possible to reduce its resistivity. Other metals may be treated according to the invention, such as for example titanium, with the aim in particular of oxidizing it and obtaining a photocatalytic titanium oxide layer.

When the coating to be treated is a low-emissivity multilayer stack, it preferably comprises, starting from the substrate, a first coating comprising at least a first dielectric layer, at least a silver layer, optionally an overblocker layer and a second coating comprising at least a second dielectric layer.

Preferably, the physical thickness of the or each silver layer is between 6 and 20 nm.

The overblocker layer is intended to protect the silver layer during the deposition of a subsequent layer (for example if the latter is deposited in an oxidizing or nitriding atmosphere) and during an optional heat treatment of tempering or bending type.

The silver layer may also be deposited on and in contact with an underblocker layer. The multilayer stack may therefore comprise an overblocker layer and/or an underblocker layer flanking the or each silver layer.

Blocker (underblocker and/or overblocker) layers are generally based on a metal selected from nickel, chromium, titanium, niobium or an alloy of these various metals. Mention may in particular be made of nickel-titanium alloys (especially those containing about 50% of each metal by weight) and nickel-chromium alloys (especially those containing 80% nickel by weight and 20% chromium by weight). The overblocker layer may also consist of several superposed layers, for example, on moving away from the substrate, a titanium layer and then a nickel alloy (especially a nickel-chromium alloy) layer, or vice versa. The various metals or alloys cited may also be partially oxidized, and may especially be substoichiometric in oxygen (far example TiOₓ or NiCrOₓ).

These blocker (underblocker and/or overblocker) layers are very thin, normally having a thickness of less than 1 nm, so as not to affect the light transmission of the multilayer stack, and can be partially oxidized during the heat treatment according to the invention. In general, the blocker layers are sacrificial layers capable of capturing oxygen coming from the atmosphere or from the substrate, thus preventing the silver layer from oxidizing.

The first and/or the second dielectric layer is typically an oxide (especially tin oxide), or preferably a nitride, especially silicon nitride (in particular in the case of the second dielectric layer, the one furthest away from the substrate). In general, the silicon nitride may be doped, for example with aluminum or boron, so as to make it easier to deposit it by sputtering techniques. The degree of doping (corresponding to the atomic percentage relative to the amount of silicon) generally does not exceed 2%. The function of these dielectric layers is to protect the silver layer from chemical or mechanical attack and they also influence the optical properties, especially in reflection, of the multilayer stack, through interference phenomena.

The first coating may comprise one dielectric layer or a plurality of, typically 2 to 4, dielectric layers. The second coating may comprise one dielectric layer or a plurality of, typically 2 to 3, dielectric layers. These dielectric layers are preferably made of a material selected from silicon nitride, titanium oxide, tin oxide and zinc oxide, or any of their mixtures or solid solutions, for example a tin zinc oxide, or a titanium zinc oxide. The physical thickness of the dielectric layer, or the overall physical thickness of all the dielectric layers, whether in the first coating or in the second coating, is preferably between 15 and 60 nm, especially between 20 and 50 nm.

The first coating preferably comprises, immediately beneath the silver layer or beneath the optional underblocker layer, a wetting layer, the function of which is to increase the wetting and bonding of the silver layer. Zinc oxide, especially when doped with aluminum, has proved to be particularly advantageous in this regard.

The first coating may also contain, directly beneath the wetting layer, a smoothing layer, which is a partially or completely amorphous mixed oxide (and therefore one having a very low roughness), the function of which is to promote growth of the wetting layer in a preferential crystallographic orientation, thereby promoting silver crystallization through epitaxial phenomena. The smoothing layer is preferably composed of a mixed oxide of at least two metals selected from Sn, Zn, In, Ga and Sb. A preferred oxide is antimony-doped indium tin oxide.

In the first coating, the wetting layer or the optional smoothing layer is preferably deposited directly on the first dielectric layer. The first dielectric layer is preferably deposited directly on the substrate. For optimally adapting the optical properties (especially the appearance in reflection) of the multilayer stack, the first dielectric layer may as an alternative be deposited on another oxide or nitride layer, for example a titanium oxide layer.

Within the second coating, the second dielectric layer may be deposited directly on the silver layer or preferably on an overblocker, or else on other oxide or nitride layers intended for adapting the optical properties of the multilayer stack. For example, a zinc oxide layer, especially one doped with aluminum, or a tin oxide layer, may be placed between an overblocker and the second dielectric layer, which is preferably made of silicon nitride. Zinc oxide, especially aluminum-doped zinc oxide, makes it possible to improve the adhesion between the silver and the upper layers.

Thus, the multilayer stack treated according to the invention preferably comprises at least one ZnO/Ag/ZnO succession. The zinc oxide may be doped with aluminum. An underblocker layer may be placed between the silver layer and the subjacent layer. Alternatively or cumulatively, an overblocker layer may be placed between the silver layer and the superjacent layer.

Finally, the second coating may be surmounted by an overlayer, sometimes referred to as an overcoat in the art. This last layer of the multilayer stack, which is therefore the one in contact with the ambient air, is intended to protect the multilayer stack from any mechanical attack (scratches, etc.) or chemical attack. This overcoat is generally very thin so as not to disturb the appearance in reflection of the multilayer stack (its thickness is typically between 1 and 5 nm). It is preferably based on titanium oxide or a mixed tin zinc oxide, especially one doped with antimony, deposited in substoichiometric form.

The multilayer stack may comprise one or more silver layers, especially two or three silver layers. When several silver layers are present, the general architecture presented above may be repeated. In this case, the second coating relative to a given silver layer (and therefore located above this silver layer) generally coincides with the first coating relative to the next silver layer.

The thin layers based on titanium oxide have the distinctive feature of being self-cleaning, by facilitating the degradation of organic compounds under the action of ultraviolet radiation and the removal of mineral soiling (dust) under the action of water runoff. Their physical thickness is preferably between 2 and 50 nm, in particular between 5 and 20 nm, limits included.

The various layers mentioned have the common distinctive feature of seeing some of their properties improved when they are in an at least partially crystallized state. It is generally sought to maximize the degree of crystallization of these layers (the proportion of crystallized material by weight or by volume) and the size of the crystalline grains (or the size of the coherent diffraction domains measured by X-ray diffraction methods), or even in certain cases to favor a particular crystallographic form.

In the case of titanium oxide, it is known that titanium oxide crystallized in anatase form is much more effective in terms of degradation of organic compounds than amorphous titanium oxide or titanium oxide crystallized in rutile or brookite form.

It is also known that the silver layers having a high degree of crystallization and consequently a low residual content of amorphous silver have a lower emissivity and a lower resistivity than predominantly amorphous silver layers. The electrical conductivity and the low-emissivity properties of these layers are thus improved.

Similarly, the aforementioned transparent conductive layers, especially those based on doped zinc oxide, fluorine-doped tin oxide or tin-doped indium oxide, have an even higher electrical conductivity when their degree of crystallization is high.

Preferably, when the coating is conductive, its sheet resistance is reduced by at least 10%, or 15% or even 20% by the heat treatment. Here this is a question of a relative reduction, with respect to the value of the sheet resistance before treatment.

Other coatings may be treated according to the invention. Mention may especially be made, non-limitingly, of coatings based on (or consisting of) CdTe or chalcopyrites, for example of CuInₓGa₁₋ₓSe₂ type, where x varies from 0 to 1. Mention may also be made of coatings of enamel type (for example deposited by screenprinting), or of paint or lacquer type (typically comprising an organic resin and pigments).

The coated substrates obtained according to the invention may be used in single, multiple or laminated glazing, mirrors, and glass wall coverings. If the coating is a low-emissivity multilayer stack, and in the case of multiple glazing comprising at least two glass sheets separated by a gas-filled cavity, it is preferable for the multilayer stack to be placed on the face in contact with said gas-filled cavity, especially on face 2 relative to the outside (i.e. on the face of the substrate in contact with the outside of the building which is on the opposite side to the face turned toward the outside) or on face 3 (i.e. on that face of the second substrate starting from the outside of the building turned toward the outside). If the coating is a photocatalytic layer, it is preferably placed on face 1, therefore in contact with the outside of the building.

The coated substrates obtained according to the invention may also be used in photovoltaic cells or glazing or solar panels, the coating treated according to the invention being, for example, an electrode based on ZnO: Al or ZnO:Ga in multilayer stacks based on chalcopyrites (in particular of CIGS—CuInₓGa₁₋ₓSe₂—type, x varying from 0 to 1) or based on amorphous and/or polycrystalline silicon, or else based on CdTe.

The coated substrates obtained according to the invention may also be used in display screens of the LCD (Liquid Crystal Display), OLED (Organic Light-Emitting Diode) or FED (Field Emission Display) type, the coating treated according to the invention being, for example, an electrically conductive layer of ITO. They may also be used in electrochromic glazing, the thin layer treated according to the invention being, for example, a transparent electrically conductive layer, as taught in application FR-A-2 833 107.

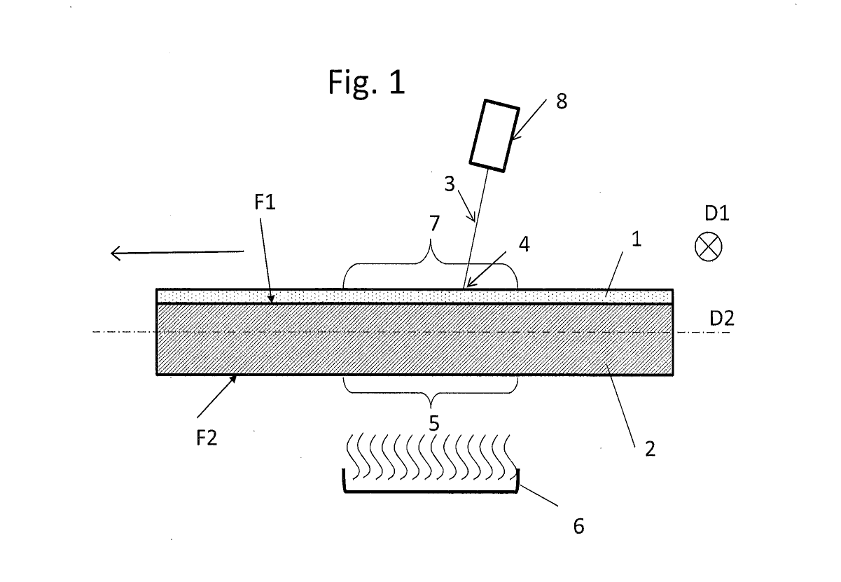

The invention is illustrated with the aid of FIG. 1 and the following nonlimiting exemplary embodiments.

FIG. 1 is a longitudinal cross-sectional schematic view of an embodiment of the invention.

The substrate 2 (typically made of glass or of glass-ceramic) and the coating 1 deposited on the first face F1 are represented in cross section in a very enlarged manner with respect to the rest of FIG. 1, since in general the thickness of the substrate 2 (a few millimeters) and of the coating 1 (a few tens or hundreds of nanometers) are very small with regard to the length of the additional heating zone 5.

The substrate 2 provided with its coating 1 on the first face F1 is made to run under a laser source 8 by virtue of displacement means that are not represented, in a second direction D2 shown by dotted lines, and along a direction shown by the arrow. The substrate 2 has two opposite (main) faces F1 and F2, respectively the first face and second face.

The laser source 8 emits a laser radiation 3 focused on the coating 1 in the form of a laser line 4 extending along a first direction D1 perpendicular to the direction D2. The length of the laser line (in the direction D1) is equal to the width of the substrate (in this same direction).

Taking into account the displacement direction, the zone located downstream of the laser line 4 corresponds in the FIGURE to the zone located to the left of the normal to the face F1 passing through the laser line 4. This zone corresponds to the portions of the coating 1 already treated by the laser line 4. The portions located to the right of this normal have not yet been treated.

Additional heating means 6 (for example infrared lamps) are positioned on the side opposite the laser line, and make it possible to heat the second face F2 in a zone 5 (additional heating zone) extending facing the laser line 4 in both directions D1 and D2, with a length in the direction D2 of at least 10 cm, for example 30 or 40 cm.

The additional heating zone 5 is here such that the ratio between its surface area extending downstream of the laser line and its surface area extending upstream of the laser line is around 65:35. Indeed, it is in the zone located downstream of the laser line that the substrate is most able to be deformed.

It is possible to measure in the zone 7, having the same surface area as the additional heating zone 5 and exactly opposite the latter, a mean temperature T₁. Similarly, it is possible to measure a mean temperature T₂ in the additional heating zone 5. Preferably, the temperature difference ΔT=T₂−T₁ is at least 8° C., for example 10° C.

A low-emissivity multilayer stack containing a silver layer is deposited by magnetron sputtering on a clear glass substrate, the surface area of which is 600×321 cm² and the thickness of which is 4 mm.

Table 1 below indicates the physical thickness of each of the layers of the multilayer stack, expressed in nm. The first line corresponds to the layer furthest from the substrate, in contact with the open air.

TABLE 1

| | |
|---|---|
| ZnSnSbOₓ | 2 |
| Si₃N₄:Al | 43 |
| ZnO:Al | 5 |
| Ti | 0.5 |
| Ag | 15 |
| ZnO:Al | 5 |
| TiO₂ | 11 |
| Si₃N₄:Al | 14 |

Table 2 below recapitulates the deposition parameters used for the various layers.

TABLE 2

| | | Deposition | |
|---|---|---|---|
| Layer | Target used | pressure | Gas |
| Si₃N₄ | Si:Al at 92:8 wt % | 1.5 × 10⁻³ mbar | Ar/(Ar + N₂) at |
| | | | 45% |
| TiO₂ | TiOₓ with x of | 1.5 × 10⁻³ mbar | Ar/(Ar + O₂) at |
| | the order of 1.9 | | 95% |
| ZnSnSbOₓ | SnZn:Sb at | 2 × 10⁻³ mbar | Ar/(Ar + O₂) at |
| | 34:65:1 wt % | | 58% |
| ZnO:Al | Zn:Al at 98:2 wt % | 2 × 10⁻³ mbar | Ar/(Ar + O₂) at |
| | | | 52% |
| Ti | Ti | 2 × 10⁻³ mbar | Ar |
| Ag | Ag | 2 × 10⁻³ mbar | Ar at 100% |

At the exit of the magnetron deposition machine, the substrate provided with its multilayer stack is conveyed horizontally at a speed of around 10 m/minute and passes under a laser line positioned perpendicular to the displacement direction. The line is obtained from laser diodes emitting a continuous radiation, the wavelength of which is 915 nm or 980 nm focused on the coating. The linear power density of the laser line is 400 W/cm, and its mean width is 53 micrometers. The line extends over a length equal to the width of the substrate.

Under these conditions, it is possible to observe a deformation in the vertical axis of around 1.2 mm, and therefore a displacement of the substrate outside of the focal plane of the laser line, which is prejudicial to the treatment.

The mean temperature T₁ measured on the first face in a zone approximately 40 cm long (along the displacement direction) around the laser line is approximately 30° C. Taking into account the conveying speed and the width of the laser line, the heat treatment only lasts approximately 1 ms (in the sense that each point of the coating is only heated for this short time). The heat does not therefore have the time to diffuse laterally, to the extent that the zones located around the laser, even a short distance away, are almost at ambient temperature.

In a second test, infrared lamps were positioned facing the second face of the substrate so as to heat a zone approximately 40 cm long (in the displacement direction), and approximately 320 cm wide (the width of the substrate). Approximately 65% of the surface area of the additional heating zone was located downstream of the laser line. The mean temperature (T₂) achieved at the second face in the additional heating zone was 40° C., measured by a CEDIP JADE infrared camera equipped with an InSb detector.

Owing to the additional heating, the deformation was no more than 0.2 mm.

The moderate additional heating focused on a zone having a much larger surface area than the surface area of the laser line therefore made it possible to very significantly reduce the deformation of the substrate.

1. A process for the heat treatment of a coating deposited on at least one portion of a first face of a substrate comprising the first face and a second face opposite said first face, the process comprising:
treating the coating by a laser radiation focused on said coating in the form of a laser line extending along a first direction, said heat treatment being such that, in a second direction transverse to said first direction, a relative displacement movement is created between said substrate and said laser line, and
locally heating said second face at a temperature of at least 30° C. in an additional heating zone extending facing said laser line over a length of at least 10 cm along said second direction, with the aid of at least one additional heater positioned on the side opposite said laser line with respect to said substrate.

2. The process as claimed in claim 1, wherein the substrate is made of glass or of glass-ceramic.

3. The process as claimed in claim 1, wherein the substrate does not bear a coating on the second face.

4. The process as claimed in claim 1, wherein the second face is heated locally over the additional heating zone extending facing the laser line over a length of at least 20 cm along the second direction.

5. The process as claimed in claim 1, wherein the second face is heated locally at a temperature of at least 40° C. in the additional heating zone.

6. The process as claimed in claim 1, the wherein a relative difference ΔT (T2−T1) between a mean temperature T2 of the second face of the substrate in the additional heating zone and a mean temperature T1 of the coating in the zone having the same surface area as said additional heating zone and exactly opposite said additional heating zone is at least 0° C.

7. The process as claimed in claim 1, wherein the length of the laser line is at least 0.8 m.

8. The process as claimed in claim 1, the wherein a mean width of the laser line is at least 35 micrometers.

9. The process as claimed in claim 1, wherein the or each additional heater is selected from a radiant heater, a convective heater, a conductive heater or any combination thereof.

10. The process as claimed in claim 9, wherein the or each additional heater is a convective heater.

11. The process as claimed in claim 9, wherein the or each additional heater is an infrared lamp.

12. The process as claimed in claim 1, wherein the coating comprises at least one thin layer selected from metal layers, titanium oxide layers and transparent electrically conductive layers.

13. The process as claimed in claim 1, wherein a maximum temperature to which each point of the coating is subjected during the heat treatment is at least 300° C.

14. A process for obtaining a substrate provided with a coating on at least one portion of a first face comprising depositing said coating on said first face and performing a heat treatment of said coating according to the process of claim 1.

15. A device for implementing the process as claimed in claim 1, comprising at least one laser source, forming and redirecting optics configured to generate a laser radiation focused on a coating, deposited on a first face of a substrate, in the form of a laser line extending along a first direction, a displacement system configured to create, during operation, a relative displacement movement between said substrate and said laser line, and an additional heater positioned on the side opposite said laser line with respect to said substrate suitable for locally heating the second face of said substrate at a temperature of at least 30° C. over an additional heating zone extending facing said laser line over a length of at least 10 cm, along said second direction.

16. The process as claimed in claim 4, wherein the length is at least 30 cm.

17. The process as claimed in claim 5, wherein the second face is heated locally at a temperature of at least 50° C. in the additional heating zone.

18. The process as claimed in claim 6, wherein the relative difference ΔT (T2−T1) is at least +5° C.

19. The process as claimed in claim 7, wherein the length of the laser line is at least 1 m.

20. The process as claimed in claim 10, wherein the or each additional heater includes nozzles blowing a hot gas.

21. The process as claimed in claim 12, wherein the metal layers are based on silver or molybdenum.

22. The process as claimed in claim 13, wherein the maximum temperature is at least 400° C.
